(19) United States
(12) Patent Application Publication
(10) Pub. No.: US 2021/0293465 A1
(43) Pub. Date: Sep. 23, 2021

(54) METHOD OF CONTROLLING A STORAGE APPARATUS AND STORAGE APPARATUS

(71) Applicant: ILLINOIS TOOL WORKS INC., Glenview, IL (US)

(72) Inventor: Kevin CARTWRIGHT, West Midlands (GB)

(21) Appl. No.: 17/202,545

(22) Filed: Mar. 16, 2021

(30) Foreign Application Priority Data
Mar. 23, 2020 (GB) 2004182.8

(51) Int. Cl. F25D 13/04

(52) U.S. Cl. CPC F25D 13/04; F25D 2700/121

(57) ABSTRACT

A method of controlling a storage apparatus having a plurality of lockable storage compartments includes: obtaining storage compartment temperature information, SCTI, for at least some of the storage compartments; obtaining order information associated with a likelihood of at least one order of items being placed for storage in the storage apparatus, the order information including order delivery information, ODI, indicative of a predicted delivery time for the order and order temperature information, OTI, indicative of a required storage temperature for at least some of the items associated with the order; determining a storage compartment temperature schedule, SCTS, in dependence on the order information, the SCTS indicative of a temperature control schedule for the at least some of the storage compartments and is determined to maximally utilize a predetermined storage capacity of the storage apparatus; and controlling the temperature of at least some of the storage compartments according to the SCTS.

### TECHNICAL FIELD

The present invention relates to a storage apparatus, particularly a locker system, particularly although not exclusively, to a multi-user locker system for the storage of goods.

### BACKGROUND

Locker systems are used for storage of items, such as goods, awaiting collection by a user. Refrigerated locker systems, where lockers are cooled to one or more predetermined temperatures, have been used in a wide range of applications. For example, WO2015114331 (to Illinois Tool Works Inc.) which teaches a temperature controlled lockable storage apparatus wherein the temperature of compartments within a locker is independently controllable to provide either a chilled or frozen temperature. Access to the lockable storage spaces is governed by an access control module which communicates with a central control system at a delivery center such as a supermarket via a communication module and grants access to the lockable storage spaces for authorized users.

Demand for lockable storage spaces at different temperatures may fluctuate. The fluctuating demand may cause issues when allocating storage spaces to users, for example due to inadequate supply of compartments at the desired temperatures.

It is an object of embodiments of the invention to at least mitigate one or more of the problems of the prior art.

### SUMMARY

According to aspects of the present invention, there is provided a storage apparatus, a computer-implemented method, a controller and computer software.

According to an aspect of the invention there is provided a computer-implemented method of controlling a storage apparatus having a plurality of lockable storage compartments wherein at least some of the storage compartments are temperature controlled. The method comprises obtaining storage compartment temperature information, SCTI, for at least some of the plurality of storage compartments. The SCTI is indicative of a temperature for each storage compartment. The method comprises obtaining order information associated with a likelihood of at least one order of items being placed for storage in the storage apparatus. The order information comprises order delivery information, ODI, indicative of a predicted delivery time for the order to the storage apparatus and order temperature information, OTI, indicative of a required storage temperature for at least some of the items associated with the order. The method comprises determining a storage compartment temperature schedule, SCTS, in dependence on the order information, wherein the SCTS is indicative of a temperature control schedule for the at least some of the plurality of storage compartments. The SCTS is determined to maximally utilize a predetermined storage capacity of the storage apparatus, the predetermined storage capacity being selected as less than a physical number of the lockable storage compartments. The method comprises controlling the temperature of at least some of the plurality of storage compartments according to the SCTS.

According to another aspect of the invention there is provided a controller for a storage apparatus having a plurality of lockable storage compartments wherein at least some of the storage compartments are temperature controlled, the controller being arranged to: obtain storage compartment temperature information, SCTI, for at least some of the plurality of storage compartments, the SCTI being indicative of a temperature for each storage compartment; obtain order information associated with a likelihood of at least one order of items being placed for storage in the storage apparatus, wherein the order information comprises order delivery information, ODI, indicative of a predicted delivery time for the order to the storage apparatus and order temperature information, OTI, indicative of a required storage temperature for at least some of the items associated with the order; determine a storage compartment temperature schedule, SCTS, in dependence on the order information, wherein the SCTS is indicative of a temperature control schedule for the at least some of the plurality of storage compartments, and wherein the SCTS is determined to maximally utilize a predetermined storage capacity of the storage apparatus, the predetermined storage capacity being selected as less than a physical number of the lockable storage compartments; and control the temperature of at least some of the plurality of storage compartments according to the SCTS.

According to another aspect of the invention there is provided a storage apparatus having a plurality of lockable storage compartments wherein at least some of the storage compartments are temperature controlled, the storage apparatus comprising a controller as described above.

### BRIEF DESCRIPTION OF THE DRAWINGS

Embodiments of the invention will now be described by way of example only, with reference to the accompanying figures, in which:

FIG. 1 shows a schematic view of a locker bank illustrating two users contemporaneously collecting delivered items;

FIG. 2 shows a schematic perspective view of a locker bank;

FIG. 3 shows a schematic view of a storage space within a locker bank;

FIG. 4 shows a block diagram showing the communication between the central control system, access control system, and the storage installation.

FIG. 5 shows a schematic view of a locker bank comprising personal communications devices as guidance means;

FIG. 6 shows a schematic view of a Delivery Driver App; a mobile app primarily for couriers;

FIGS. 7A-7C show a schematic view of a Consumer App; a mobile app primarily for consumers;

FIG. 8 shows a method of controlling a storage apparatus; and

FIGS. 9A-9C illustrate an example storage installation, order information and storage compartment temperature schedule.

### DETAILED DESCRIPTION OF EMBODIMENTS OF THE INVENTION

A distribution network is a group of connected storage facilities and transportation systems that receive goods and then deliver them to consumers.

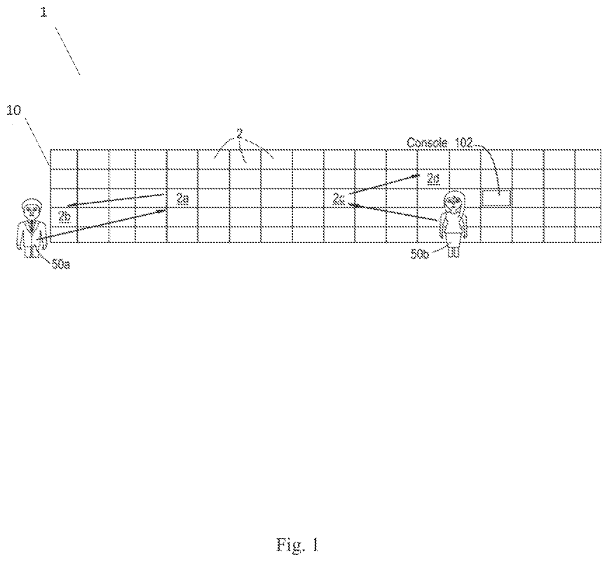

FIG. 1 illustrates a distribution network comprising a storage installation 1. The storage installation 1 at a given collection site may comprise a plurality of lockable storage spaces 2, arranged either in a single locker bank 10 on a given footprint at the collection site, or in two or more separate locker banks 10 typically grouped close to one another on a given footprint at the collection site. At least one user 50 is guided to their allocated lockable storage space(s) 2, more specifically a subset of a plurality of lockable storage spaces 2.

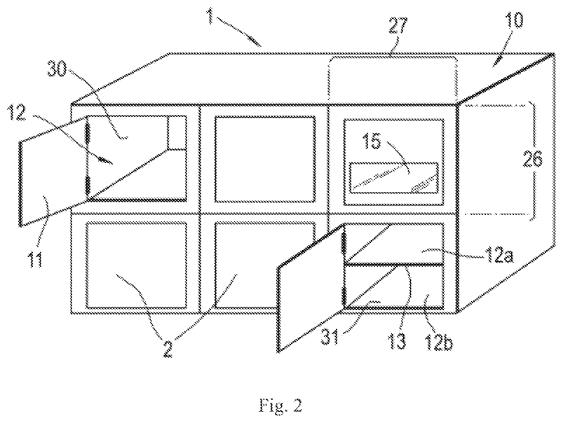

FIG. 2 illustrates a single locker bank 10. Each storage space 2 comprises at least one compartment 12. Additional compartments 12 can be created within a storage space 2 using at least one horizontal, vertical and/or diagonal divider 13 to separate the compartments. The compartments 12 within a storage space 2 may be equal or different in volume and/or shape. Typically, the storage spaces 2 are lockers, i.e. each having a respective lockable door 11; but may also comprise drawers as some items, such as round items, may roll out when a door 11 is opened. The door 11 is typically mounted to the locker bank 10 by a hinge or pivot 21, though any other suitable mounting arrangements, e.g. sliding doors or doors with compound articulations, may also be used; throughout or in any suitable combination. The storage spaces 2 need not comprise a conventional door 11, but instead may have an inner member and an outer member which are moveable or slidable with respect to one another about or along a common axis. Storage spaces 2 may be equal to each other in size and/or volume, or may be different to each other in size and/or volume. Typically, the storage spaces 2 are generally box shaped (rectangular/square parallelepiped-like volumes).

In the case of more conventional generally box-shaped storage spaces 2, these may be joined together side by side in the or each locker bank 10, and usually share side walls 30. The plurality of lockable storage spaces 2 may be positioned such that they are adjacent to one another. For example, a storage installation 1 may comprise one locker bank 10, wherein a locker bank 10 comprises a plurality of storage spaces 2.

Alternatively, a storage installation 1 comprises two or more locker banks 10 wherein each locker bank 10 is placed proximate to another.

FIG. 2 illustrates a locker bank 10 with six storage spaces 2; however, a locker bank 10 can be arranged in a multitude of ways. Preferably, a locker bank 10 has two or more storage spaces 2 wherein the two or more storage spaces 2 are arranged in at least one row 26 and/or at least one column 27 in locker bank.

One or more of the storage spaces 2 in the subset allocated to said at least one user may store goods requiring a particular storage condition, such as a temperature. The user 50 may be a consumer or a courier (delivery person). A consumer may collect goods from a plurality of lockable storage spaces 2 allocated to them. A courier may deliver goods to a plurality of lockable storage spaces 2 allocated to them. Optionally, a consumer may deliver goods to a plurality of lockable storage spaces 2, i.e. in the case of returning the goods. Optionally, a courier may collect goods from a plurality of lockable storage spaces 2 which are returned or uncollected by the consumer.

In embodiments of the present invention, the one or more of the lockable storage spaces 2 store goods which require different storage conditions, in particular different temperatures. The different temperatures may include a frozen temperature, chilled temperature and controlled ambient conditions.

The chilled temperature represents the temperature range for storage of groceries such as milk and yogurt, etc. and covers a range between substantially 0 degrees Celsius to substantially 4° C. The frozen temperature represents the temperature range for storage of frozen groceries such as ice cream and frozen food. For the purpose of the present invention, the frozen temperature covers a range between substantially −25° C. to substantially 0° C., more preferably between substantially −21° C. to substantially −18° C. Preferably, the temperature of each of the one or more compartments is independently controllable to provide any one of ambient or chilled or frozen temperature. The ambient temperature represents the temperature range for storage of typical groceries such as chocolate or dry goods. For the purpose of the present invention, ambient temperature covers a range between substantially 4° C. to substantially 21° C. For the purpose of this invention and all the prior applications, the term “ambient temperature” is construed to mean “room temperature” or more appropriately “controlled ambient temperature”. It does not refer to the actual air temperature of the surrounding environment, for example the sub-zero temperature experienced during the winter months; rather “ambient temperature” means a temperature range suitable for storing goods that do not require refrigerated storage to remain in saleable condition.

Each compartment 12, 12a, 12b of the storage space 2 may comprise at least one variable which is independently controllable, wherein the variable may be temperature, humidity, other atmospheric composition and/or pressure, for example. A subset of the compartments 12, 12a, 12b within a storage installation 1 can for example be in controlled to provide a selectable specified condition whilst another subset of the compartments 12, 12a, 12b within the same storage installation 1 can for example be controlled to provide another selectable specified condition, wherein the selectable specified condition comprises temperature, humidity, other atmospheric condition or composition, pressure etc. Therefore, a user 50 having ordered a variety of goods requiring different storage conditions, e.g. frozen goods and chilled goods, may need to go to two or more separate storage spaces 2 within the storage installation 1 to collect their goods as they will not necessarily be stored together within the same storage space 12. A subset within a storage installation 1 may comprise storage spaces 2 from separate locker banks 10.

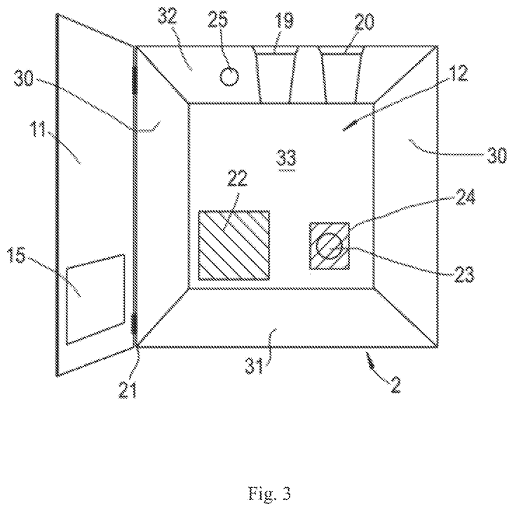

FIG. 3 illustrates a compartment 12 which may comprise a side wall 30, a lower wall 31, an upper wall 32 and a rear wall 33. In order to prevent items contained within a compartment 12 of storage space 2 from rolling or falling out of the compartment 12 upon opening the door 11 to the storage space 2, the lower wall 31 of at least one storage space may be tilted such that it is declined between the edge nearest the door 11 towards the rear wall 33. The angle of decline is preferably between 0 and 10 degrees from the horizontal plane, more preferably between 0 and 5 degrees from the horizontal plane. Alternatively or additionally a horizontally configured divider 13 which is placed in the storage space 2 to create two compartments 12a, 12b (see FIG. 2) may also be declined as described above, to prevent items from falling or rolling out of the upper compartment 12a created by the divider 13. Additionally or alternatively the lower wall 31 and/or the horizontal divider may comprise a lip or threshold adjacent the opening, for a similar purpose.

FIG. 3 shows an internal view of a storage space 2 with one compartment 12. In this exemplary embodiment, the compartment comprises an air conditioner or dehumidifier 22 for dehumidifying the compartment 12. The storage space 2 may comprise an inlet/outlet 23 for a vacuum pump in order to allow control of the pressure within the storage space 2. The compartment 12 may comprise interior illumination such as from a light source 20 facilitating collection and inspection of stored items. The light source 20 may be switched on when the door 11 opened or unlocked, and the light source 20 may be switched off when the door 11 is closed or locked. Optionally, the light source 20 may be switched on or off regardless of the state of the door 11 or lock. In case of a fire within at least one compartment 12, the compartment 12 may be equipped with an active fire protection system 19 such as a fire sprinkler system.

The door 11 may comprise a window 15 such that light can be transmitted from the surroundings to within the at least one compartment 12 of the storage space 2. This can be useful if the item(s) in the compartment 12 require light, e.g. plants. The window may be transparent or translucent. The window 26 may be a smart window such that it can dim or undim by using electrochromic glass which can change from light to dark (i.e. transparent/translucent to more or completely opaque), and back again. The change from light to dark of the electrochromic glass may occur on locking or unlocking the door 11 of the storage space 2, or vice versa. In case the goods stored in the compartment 12 comprises a plant, a plant watering system can be fitted into the compartment 12 such that the plant is watered at set intervals or watering can be controlled manually, controlled remotely or programmed.

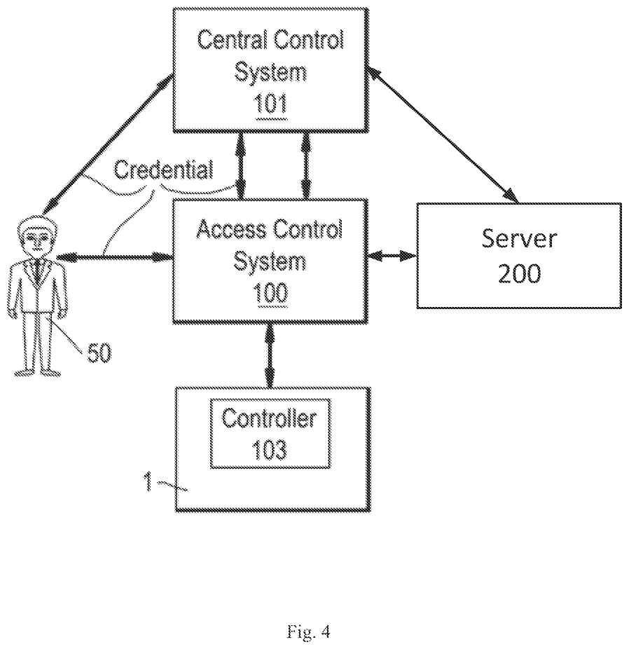

FIG. 4 illustrates a schematic control system for the distribution network.

A central control system 101 within the distribution network may allocate the lockable storage spaces 2 for goods which have been ordered, e.g. online, by a user 50. Based on status information of the lockable storage spaces 2, the central control system 101 may allocate at least one suitable vacant or available storage space 2 for goods deliveries or consignments. The user 50 is allocated one or more storage spaces 2 depending on the condition-requirements of the goods ordered for delivery to a collection point, e.g. chilled, frozen and/or controlled ambient. The central control system 101 may be coupled to an access control system 100, as will be described.

An order can be placed by a user 50 such that the goods ordered will be delivered to at least one of the lockable storage spaces 2, i.e. a subset of the plurality of lockable storage spaces 2, located at a collection site. Once a user 50 has successfully placed an order, the allocation of the subset of a plurality of lockable storage spaces 2 allocated to said user 50 will be stored in a database along with, but not limited to, the user's identity and a list of the ordered goods. The database may be stored on a data storage device wherein the data storage device may be located in the central control system 101. The data storage device may comprise cloud storage 240 or be located in a supermarket or at a delivery center, or locally within the storage installation 1. The database is coupled to the access control system 100 by way of the central control system.

The lockable door 11 of each storage space 2 is actuated by the access control system 100 to permit a user 50 to gain access to at least one of a subset of the plurality of lockable storage spaces 2. The access control system 100 comprises an access control processor. The access control processor can be any processing device known in the art. Typical examples include but are not limited to a microprocessor. The processor can be communicatively coupled to computer readable media such as a memory device. Different access control systems 100 commonly known in the art are permissible in the present invention. Commonly known access control systems are through the use of barcodes or machine readable media.

A guidance means is configured to guide the user 50 to the allocated storage space 2 once the user 50 has been granted access to their respective subset of allocated storage spaces 2 by the access control system 100. The guidance means is configured to contemporaneously or concurrently guide two or more users to at least part of their respective subset of lockable storage spaces 2. In some embodiments, the access control system 100 may comprise the guidance means, and the guidance means may be operable by the access control processor. In some embodiments, the guidance means may be a guidance device of a user as will be explained.

In one example as shown in FIG. 1, a first user 50a is allocated storage spaces 2a and 2b and a second user 50b is allocated storage spaces 2c and 2d. The guidance means of the present invention can guide the first user 50a to storage space 2a in a variety of ways, examples of which are detailed below. Once the user 50a has collected their ordered goods from the storage space 2a, the guidance means will then direct the user 50a to their second allocated storage space 2b. Alternatively, the guidance means may provide the user 50a with an indication of a location sequence of the subset of lockable storage spaces 2a and 2b at the same time, i.e. upon user registration at the locker bank 10. For at least some of the time during which the first user 50a is being guided for collection of their ordered goods from their allocated storage spaces 2a, 2b, the disclosed storage space access control arrangements permit the second user 50b (and possibly still further users, not shown) to be guided for collection of their goods from their allocated storage spaces (2c, 2d in the case of second user 50b) too.

In order to collect the ordered goods from the subset of a plurality of lockable storage space(s) 2, the user 50 must first confirm that they are in fact the same user 50 that made the order or have been authorized by said user 50 to collect the goods. The access control system 100 grants access to the subset of the lockable storage space 2 allocated to a user 50 provided that it identifies a user based on a credential, and this user identity via the credential matches the user identity stored in the database. This is also referred to as user registration.

The credential may include any one of, but is not limited to, a machine-readable medium such as a barcode or a passcode, a contact payment card, a contactless payment card, a contact smart card, a contactless smart card, an identity document such as a passport or a driver's license, a biometric input or a personal communications device such as a smartphone or a tablet. The biometric input may include, but is not limited to, at least one of a fingerprint, face recognition, hand geometry, iris recognition, retina, palm veins, DNA, palm print, and odor/scent. Geolocation can be used to determine that a credential is in a given place (e.g. in the vicinity of a bank of storage spaces) and can therefore be used to verify a credential, such that, upon user arrival at the collection site, the access control system 100 grants access to the subset of lockable storage spaces 2. The credential may be presented by the user 50 to the access control system 100. In some cases, where the access control system 100 is located in the storage installation 1, the access control system 100 may comprise at least one access control console 102 as illustrated in FIG. 1. The at least one console 102 may comprise a user interaction means and/or means to read/input the credential, e.g. a fingerprint reader, retina recognition or low power wireless communication protocols, e.g. Bluetooth®, Zigbee® etc. The user interaction means may comprise at least one of a display screen and/or a loudspeaker and/or input device and/or graphical user interface and/or a microphone. In the case that the console comprises a display screen, the display screen may be arranged in a portrait or a landscape orientation. The user 50 may register by presenting their credential at the at least one console 102. The access control system 100 compares the credential data with the information stored in the database; if there is a match, access to a subset of the plurality of lockable storage spaces 2 will be granted to the user 50, otherwise access will be denied. The advantage of this is that by having more than one console 102 per locker bank 10, two or more users can contemporaneously register to be granted access to their respective subsets of lockable storage spaces 2.

Once the user 50 is granted access to their respective subset, at least one of the guidance means may be engaged to guide the user 50 to each storage space 2.

The access control system 100 is coupled to a controller 103 located in the storage installation 1 which can control the lock status of each storage space 2.

The first storage space 2 allocated to said user is unlocked or opened and the user 50 retrieves their goods from the first storage space. Acknowledgement that the goods have been retrieved from the first storage space storage space 2 can be determined by the user closing the door or the storage space senses that goods have been removed from the storage space, e.g. senses a change in weight (load cell), interruption in light, motion sensor etc. Upon closing the first storage space 2, the controller 103 may lock the first storage space 2, and the guidance means will communicate to the user 50 the location of the subsequent storage space 2 in their subset.

The access control system 100 may communicate to at least one personal communications device 230 of a user 50. The at least one personal communications device may be utilized for user registration, or as a guidance means, or both, as will be explained.

Examples of a personal communications device 230 are a cellular phone, tablet, smart phone, smart watch, laptop etc. The communication between the access control system 100 to the user's personal communications device 230 may be wireless means such as email, Bluetooth®, WiFi, Zigbee, induction wireless, ultra Wideband (UWB), infrared wireless, near-field communication (NFC) and/or radio-frequency identification (RFID) etc. The user 50 may present a credential via their personal communications device 230, and if it matches the identity of a user 50 stored in the database that was allocated a subset of a plurality of lockable storage spaces 2, may be granted access to their respective subset of lockable storage spaces 2. Therefore, a user 50 can be granted access to their respective subset of a plurality of lockable storage spaces 2.

The distribution network comprises a server 200. The server 200 may be located in or proximate to the storage installation 1, or may be remote from the storage installation 1. An application may be stored in the server 200, and this application may communicate with a mobile app on the user's personal communications device 230. A user may set up an account with a retailer and provide details of preferred collection sites which could be close to home or work as well as providing personal details such as name, address, payment details, e.g. bank or Paypal®. The personal details of the user are stored in a database which could be located in the server 200 of the distribution network and is managed by the central control system 101. The central control system 101 may also link to a delivery system which manages delivery of goods to a user's preferred collection sites according to their preferences in their account. A user having an account with the central control system 101 can log onto a website associated with the central control system. The website has a link to at least one retailer and/or delivery system associated with the central control system. Access to the website can be through the user's personal communications device, e.g. via a mobile app.

The application in the server 200 may communicate with the access control system 100 such that the user 50 can register for access to their respective subset of a plurality of lockable storage spaces, and also be guided by their mobile app on their personal communications device 230.

Therefore, once a user 50 has registered and been granted access by the access control system 100, at least part of the location sequence may be communicated to the user 50 via the mobile app on the personal communications device 230. Alternatively, the application in the server 200 delivers at least part of the location sequence to the user's personal communication device 230 by email or SMS, or other means, other than via the mobile app. Alternatively, the personal communications device 230 is only used for user registration, and the user 50 is guided to their respective subset of a plurality of lockable storage spaces 2 by at least one other guidance means, as will be described.

Alternatively, the user registration is completed via the at least one console, and the user 50 is guided to their respective subset of lockable storage spaces 2 by their personal communications device 230. In this case, once a user has registered at the console, the console or access control system 100 may communicate to the user's personal communications device 230 the location of the storage space 2, and once the user has retrieved their goods from said storage space 2 (i.e. closed the storage space 2), the console or access control system will again communicate to the user's personal communications device 230 indicating the location of the subsequent storage space. In some cases, the entire location sequence may be communicated to the user by way of the personal communications device 230. The communication may be via at least one wireless, such as Bluetooth, emitter which is located proximate to the storage installation. Alternatively, the communication may be via any wireless means between either the storage installation 1 and the personal communications device 230, or between the server 200 and the personal communications device 230.

The personal communications device 230, having received the location sequence from the access control system 100, may guide the user 50 by any sensory channel of said user 50, or combination of sensory channels of said user 50. For example, the personal communications device may display a visual/graphical guide showing the storage spaces location within the storage installation 1, or display a textual guide which says “4C”, or display an augmented reality view. Optionally, or additionally, the personal communications device may playback an auditory guide, for example, different tones depending on the distance the user is from the allocated storage space 2 (i.e. proximity/directional guidance) or synthesized speech whereby the loudspeaker of the device will provide directional and/or instructional guidance (i.e. “left, then forward, then right” and/or “Your next locker is 4C”). Further optionally, the personal communications device 230 may provide haptic feedback for proximity/directional guidance, for example, the device will vibrate when within a pre-determined distance from the allocated storage space 2; and/or guide the user towards the allocated storage space by varying the haptic output depending on proximity to it. Not all of these guidance means by sensory channels need be implemented on a personal communications device; they may optionally be centrally or selectively distributedly displayed or broadcast by suitable display screens and/or loudspeakers and/or any other guidance means disclosed herein and located in or proximate to the storage installation 1.

The access control system 100 may comprise one or more wireless emitters to broadcast guidance instructions to a user's personal communications device 230. The wireless emitter may comprise any common wireless means known in the art such as Bluetooth, Zigbee or wi-fi emitters. The user may pair their personal communications device 230 with the access control system during user registration so as to allow the broadcasts to be announced by their personal communications device 230. This broadcast signal can provide guidance instructions to the user 50 by any sensory channel, as discussed above (e.g. visual/graphical, auditory and/or haptic).

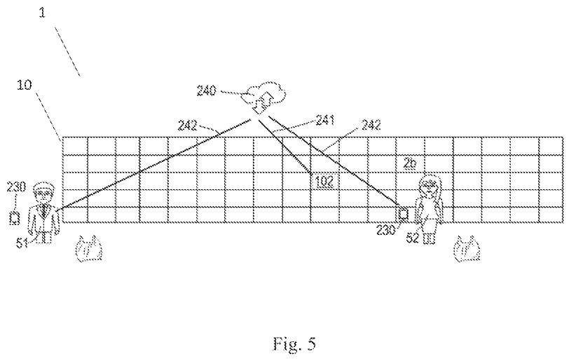

Referring to FIG. 5, when a first user 51 registers with the access control system 100, a processor within the locker bank 10 at the storage installation 1, or even remote from storage installation 1, communicates with the first user's personal communications device 230, which may comprise an application. Alternatively or additionally, the locker bank 10 and/or its storage spaces 2, 2a, 2b may comprise communication means 241 in communication with an access control program e.g. running in the cloud 240. The access control program may be processed by the processor in the server 200 of the distribution network or by a separate processor that is remote of the server 200. The cloud 240 may form part of the central control system. The consumer's personal communications device application and the access control program are “linked” by the customer order number or equivalent identifier (which is assigned to the customer when placing the order, and stored in a database wherein the database is located in the distribution network, e.g. in the central control system 101, e.g. stored in the cloud 240) such that the personal communications device 230 and the cloud 240 are in communication via communication means 242. The access control program may communicate to the user 50, by way of the user's personal communication device 230, at least part of the location sequence of said user's respective subset of lockable storage spaces 2 from the cloud 240 via communication means 242. When the user 51 closes the storage space 2a after having collected their ordered goods from the lockable storage space allocated to them, the processor in the locker bank and/or the access control program communicate (via communication means 241) with the user's personal communications device 230 such that the location of the next storage space is communicated to the user 51 and/or the subsequent storage space in the user 51's allocated subset is unlocked and ready for the ordered goods to be collected by the user 51. A second user 52 with an allocated subset of lockable storage spaces which includes storage space 2b may be guided to such a subset by the same means described above for the first user 51, i.e. the first user 51 and second user 52 are contemporaneously (at least partly simultaneously) guided to their respective subsets of lockable storage spaces 2a, 2b. This is discussed in more detail below. Communication means 241 and 242 may be any of email, wi-fi, SMS etc.

As disclosed above, there are two user registration means via the access control system 100; these are through (i) the at least one console 102 or (ii) the personal communications device of the user 50. The guidance means may include at least one of the at least one console, at least one scanner station, a customer information display system, at least one printer, the personal communications device 230 and any of the other guidance means disclosed herein.

The access control system 100 may comprise at least one printer as a form of guidance means. The at least one printer may operate in conjunction with the at least one console 102. Upon registration by way of the access control system 100, the printer may print a note indicating the location sequence of the subset of lockable storage spaces allocated to a user 50. The note may also include a machine readable medium and/or alphanumeric code which may also act as a credential for access to a respective subset of the lockable storage spaces 2. The at least one printer may be positioned in a locker bank 10, preferably proximate to each console 102. Optionally, the access control system 100 may not comprise a printer but a pre-printed note/receipt is provided together with the goods contained by the first allocated lockable storage space of a user's respective subset. The note may comprise a credential for opening any further allocated storage spaces 2 associated with that order.

The access control system 100 may comprise a customer information display system as a form of guidance means. The customer information display system may comprise at least one customer information display panel. Upon registration, by way of the access control system 100, the customer information display system will indicate the location sequence or subsequent storage space 2 of a respective subset of lockable storage spaces 2 to a user 50 via at least one customer information display panel.

The access control system 100 may comprise at least one scanner station as a form of guidance means, whereby, following user registration and retrieving their goods from their first allocated storage space 2, the user 50 then goes to such a scanner station which will communicate to the user 50 the subsequent storage space of their respective subset when the user 50 presents a credential at the scanner station.

Other guidance means may include one or more of: a storage space number display system in which each storage space 2, comprises a storage space number display screen; a light-based display; an optical head-mounted display and/or other head-mounted device; a path projection system comprising at least one projector; or a loudspeaker system. Any guidance means disclosed herein may be used in combination with any other guidance means also disclosed herein. It will become apparent how this is possible, and why it may be advantageous, through this disclosure.

Upon placing the order or during setting-up of an account with the central control system 101 or during user registration with the access control system, the user can select a preferred type of guidance means. This may be advantageous where the user has a physical disability. For example, a visually impaired user may select to be guided by a loudspeaker system and/or haptic feedback and/or a refreshable braille display input device guidance means.

When employing any of the guidance means, the access control system 100 may facilitate the unlocking/opening of subsequent allocated storage spaces 2 when the preceding allocated storage space 2 has had its contents retrieved by the user 50 and the preceding storage space 2 has been closed. The access control system 100 may unlock a subsequent storage space when its location is communicated to the user 50, and lock said storage space 2 when it is closed. Alternatively, the user may need to manually open/unlock the storage space that they have been guided to. This may involve a user 50 inputting a code to an input device and/or presenting a credential to a scanner/reader to open/unlock the storage space 2 allocated to said user 50.

Access by the access control system 100 to each lockable storage space 2, or a subset of lockable storage spaces 2 allocated to a user 50, is governed by electronically locking/closing and unlocking/opening the storage space 2, upon verification of user identity based on a credential of said user 50. The electronic locking mechanism can be any mechanism known to the person skilled in the art such as an electromagnetic lock (“maglock”), an electronic strike or electronic deadbolts and latches. The access control system 100 may also monitor the status of each storage space 2 and transfers the status information to a server 200. Status information may include, but is not limited to, at least one of temperature information, dehumidifier information, vacuum information, the light source information, occupancy information, compartment size information, window information, fire sprinkler system information, lock information, and alarm condition information.

The access control system 100 may be coupled to a controller 103 located in the storage installation 1 which can control the lock status of each storage space 2, as shown in FIG. 4.

The sequence by which the allocated storage spaces are arranged in the collection sequence or sequences may be determined by employing at least one algorithm to solve the “shortest path problem” or the “travelling salesman problem”. Additionally or alternatively, the path may be determined by one or more of a heuristics approach; whether goods stored in particular conditions or having particular characteristics should be collected first or last; a user preference; and the location of other users also collecting their goods from their respective subsets of lockable storage spaces 2, in order to prevent overcrowding.

A benefit of the present invention is that the access control system 100, particularly in response to the guidance means, can facilitate two or more users to contemporaneously or at least partially simultaneously collect their ordered goods from their respective subsets of a plurality of lockable storage spaces 2. In one example, a first user 50a is being guided by the guidance means to a first subset of lockable storage spaces 2 allocated to said first user 50a. In the same example, a second user 50b is contemporaneously guided by the guidance means to a second subset of lockable storage spaces 2 allocated to said second user 50b. This is only made possible by the guidance means detailed above; without such means, each subsequent user 50 must wait for the preceding user 50 to complete the collection of their ordered goods from their respective subset of lockable storage spaces 2, and return to the console 102 (which also may not allow simultaneous or contemporaneous user registration by a plurality of users 50).

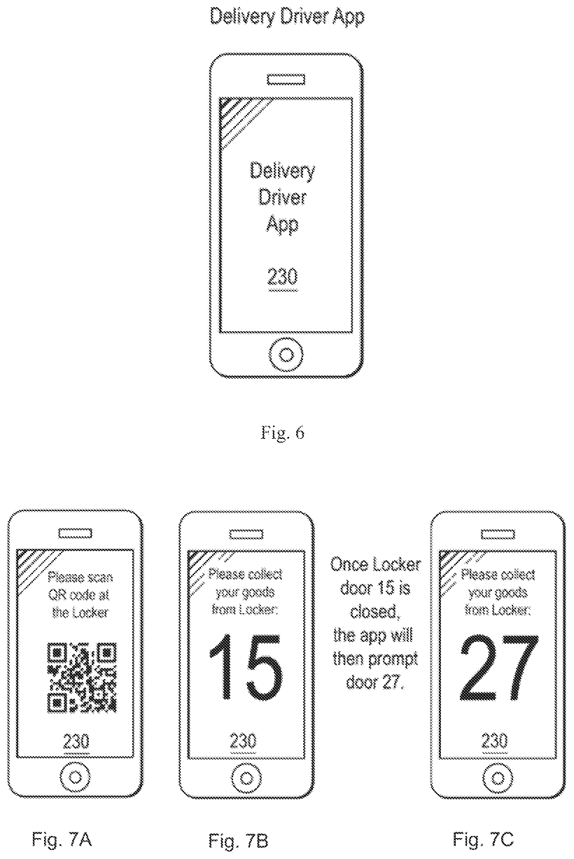

FIG. 6 shows an example of a mobile app for users, in particular the courier or delivery driver, on a personal communications device 230. This mobile app for use by couriers or delivery drivers is referred to as a Delivery Driver App. The Delivery Driver App may register with the access control system (which may be located at the storage installation) by wireless means, such as Bluetooth or Wi-fi. Once the user of the Delivery Driver App is connected to the access control system, the Delivery Driver App may provide a delivery procedure via the personal communications device guiding said user to deliver goods to a subset of lockable storage spaces by at least one guidance means, e.g., but not limited to, any of the guidance means described above.

FIGS. 7A-7C show examples of a mobile app for users, in particular consumers placing and taking delivery of goods orders, on a personal communications device 230. This mobile app for use by consumers is referred to as the Consumer App. The Consumer App may register with the access control system (which may be located at the storage installation) by wireless means, such as Bluetooth or Wi-fi. The Consumer App will navigate the user through the “click and collect” experience. Once a user has registered, such as by scanning a machine-readable medium (FIG. 7A) provided by the Consumer App at an input device, the access control system will consistently “broadcast” both the order number and the next storage space or spaces in the collection sequence. The application will “ignore” the subsequent storage space message if the order number or like identifier does not match that of the user that is using the Consumer App. A user may use a machine-readable medium to open/unlock one of their allocated storage spaces 2. Once the allocated storage space 2 is closed/locked, the Consumer App may then prompt the user to collect their goods from a subsequent allocated storage space by displaying the subsequent allocated storage space on the display screen of the personal communications device as shown in FIGS. 7B & 7C. Optionally, or additionally, the mobile app may prompt the user to collect their goods from a subsequent allocated storage space by utilizing an alternative guidance means, as described above.

It has been observed that demand from users 50 for capacity at different storage temperatures may fluctuate over time. It may therefore be desired to control a distribution of operating temperatures of lockable storage spaces 2 in response to or in anticipation of changing user demand.

It is also desired to provide allowance for unexpected events such as lockable storage spaces 2 becoming unusable. For example, the lockable storage spaces 2 may be rendered unusable due to equipment failure and/or user events such as vandalism. Additionally, orders may change dimension due to for example replacement of items, and more storage spaces 2 may be flexibly required upon receipt of an unexpectedly larger order than planned.

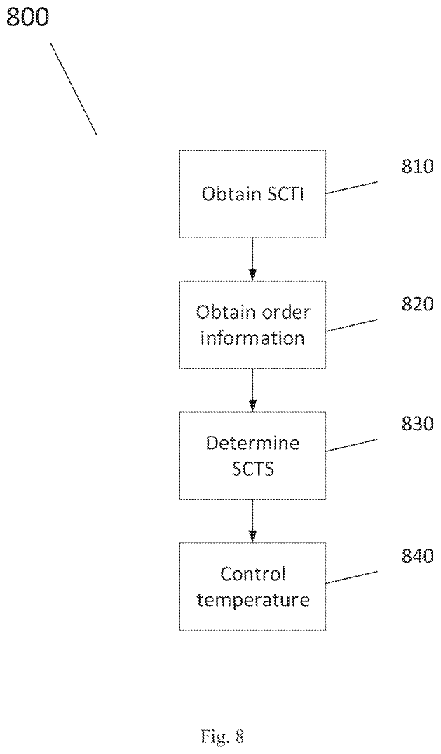

FIG. 8 illustrates a method 800 of controlling a storage apparatus having a plurality of temperature controlled lockable storage compartments, according to an embodiment of the invention. The method 800 will be described with reference to controlling the storage installation 1 comprising the temperature controlled lockable storage compartments 12, as have been described. However, it will be appreciated that the method 800 may be applied to control other storage apparatus. Aspects of the method 800 may be performed by the central control system 101.

The method 800 comprises a step 810 of receiving storage compartment temperature information (SCTI) for at least some of the lockable storage compartments 12. The SCTI is indicative of a temperature for each storage compartment 12. The SCTI may be indicative of a current temperature or temperature range for each compartment 12, for example 0° C., or −3° C. to 1° C. The SCTI may in some embodiments comprise an indication of a temperature condition for each storage compartment 12. For example, the temperature conditions may comprise frozen temperature, chilled temperature and controlled ambient temperature conditions as have been described previously. According to some embodiments, the SCTI may be indicative of a desired temperature for each compartment 12, i.e. a planned temperature based on a current schedule. For example, one or more compartments may be in the process of cooling to a frozen temperature.

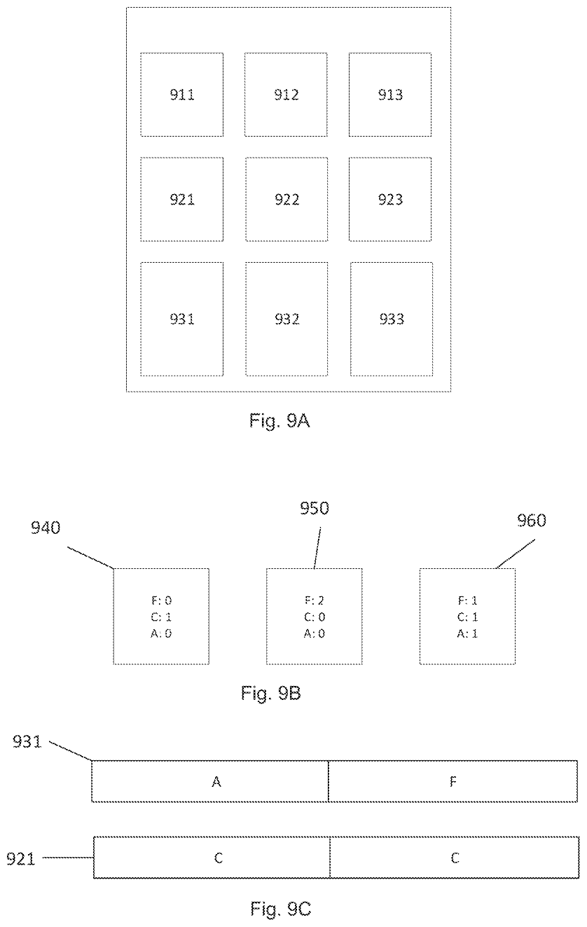

FIG. 9A illustrates an example storage installation 1 comprising nine storage compartments 911 to 933. Step 810 may comprise receiving SCTI indicating that compartments 911, 912 and 913 are frozen, compartments 921, 922 and 923 are chilled, and larger compartments 931, 932 and 933 are ambient controlled.

Future demand for different temperature conditions in the lockable storage compartments 12 may differ from a current temperature configuration or schedule as represented by the SCTI. The future demand may be estimated by accounting for actual orders and predicting likely upcoming orders.

The method 800 comprises a step 820 of obtaining order information associated with a likelihood of at least one order of items being placed for storage in the storage apparatus. Each order associated with the order information comprises one or more items. The order information may be associated with an order that has been already placed, a prediction of likely upcoming orders based on historical orders, or a combination of the two.

As has been described, an order can be placed by a user 50 for goods to be delivered to the lockable storage compartments 12, e.g. via an online order. In this case the central control system 101 may receive a storage request from a remote computer system (for example a home computer of the user, or the server 200) indicative of the placement of the order of items for storage in the storage installation 1. Step 820 then may comprise obtaining the order information in dependence on the storage request placed by the user.

In the case of likely upcoming orders based on historical orders, step 820 may comprise obtaining historic order information associated with a plurality of historic orders of items for storage in the storage installation 1. The historic order information may be stored accessible to the central control system 101, for example on the server 200. Step 820 then may comprise retrieving said historic order information. The historic order information is indicative of at least one historic order of items, including historic delivery information indicative of the time at which the historic order was delivered to the storage installation 1, and historic temperature information indicative of the temperature conditions required in the storage compartments 12 for receipt of the historic order. For example, the historic order information may indicate that on Jun. 4, 2019, an order was delivered to the storage installation 1 at 13:34 requiring one chilled and two frozen storage compartments 12. The historic order information may comprise an indication of the space required for the items, for example 40 cm×20 cm of chilled storage space. The historic order information may comprise details of the items therein. The historic order information may optionally comprise information indicative of the time at which the order was placed by the user 50, for example 23:22 on Jun. 3, 2019.

Step 820 may then comprise determining the order information to indicate one or more predicted orders, wherein the one or more predicted orders are determined in dependence on the historic order information.

The one or more predicted orders may be determined based on the time at which one or more historic orders were delivered. An order may be predicted by extrapolating a historic trend. For example, the historic order information may indicate a user 50 regularly placing an order, for instance in the form of a weekly grocery shop. The central control system 101 may then determine a predicted order in dependence on the historical trend of the regularly placed orders.

According to some embodiments, the historic order information may comprise historic contextual information regarding each historic order. The contextual information may comprise historic weather information indicative of weather conditions associated with each historic order. The contextual information may comprise information regarding holidays, for example bank holidays or festivals which may be associated with adjusted purchasing patterns.

The contextual information such as the historic weather information may then be utilized in determining the one or more predicted orders. Step 820 may comprise obtaining predicted contextual information, for example predicted weather information or holiday information from an external source. Step 820 may then comprise determining one or more predicted orders for the order information in dependence on the historic contextual information and the predicted contextual information.

For example, the historic order information may indicate that higher numbers of frozen storage compartments 12 have been required at times when the temperature is above a threshold. Step 820 may then comprise predicting an increased number of orders requiring frozen storage compartments 12 due to predicted weather information indicating a temperature above the threshold. It will be appreciated that other weather conditions and contextual information may be used to perform inference for predicted orders in a similar manner.

The order information comprises order delivery information (ODI) and order temperature information (OTI) associated with each order.

The ODI is indicative of a predicted delivery time for the order to the storage apparatus, i.e. a time at which it is expected the items in the order will be delivered to the lockable storage compartments 12. The ODI may for example, in the case or orders already placed, be determined by the central control system 101 in dependence on delivery information received from the delivery service or courier. For predicted orders, the ODI may be predicted in dependence on historical delivery times.

The OTI is indicative of a required storage temperature for at least some of the items of the order. The OTI may be indicative generally of the temperature conditions required for storage of the order, for example that the order requires storage at a frozen temperature and an ambient temperature, but not a chilled temperature. In particular the OTI may be indicative that a first one or more items of the order require a first storage temperature, and a second one or more items require a second storage temperature.

According to some embodiments the OTI may comprise a more detailed capacity requirement at each temperature condition. For example, the OTI may comprise an indication of a total volume required for storage at each temperature condition, a number of storage compartments 12 required at each temperature condition, or a number of items required to be stored at each temperature condition.

For example, FIG. 9B illustrates example order information comprising one received order 940 and two predicted orders 950, 960. Collectively, the example order information indicates that three small frozen storage compartments 12, two small chilled storage compartments 12 and one small ambient compartment 12 are required in 12 hours' time.

The order information and SCTI may then be utilized to plan a temperature schedule for the lockable storage compartments 12 responsive to the actual and/or predicted demand exemplified by the order information.

The method 800 comprises a step 830 of determining a storage compartment temperature schedule (SCTS) in dependence on the order information. The SCTS is indicative of a temperature control schedule for at least some of the plurality of storage compartments 12. The SCTS may indicate a target temperature (e.g. frozen) for each storage compartment 12, and optionally a time by which the storage compartment 12 should reach or be at the target temperature.

The SCTS is determined to maximally utilize up to a predetermined storage capacity of the storage apparatus. By maximally utilize, it is meant to maximize the number of orders capable of being stored within the predetermined storage capacity. In this way the usage of the storage compartments 12 may be optimized within a predetermined capacity. For example, the predetermined storage capacity may be maximally utilized by maximizing the number of remaining unoccupied storage compartments 12 within the predetermined storage capacity available to receive further orders.

For example, in the example of FIG. 9B, two small frozen storage compartments 12 are scheduled to be utilized by the same order 950. Capacity may be more maximally utilized by allocating one large frozen storage compartment in the place of the two small frozen storage compartments. In this case, the SCTS may be determined to accommodate one large frozen storage compartment.

FIG. 9C illustrates a portion of an example SCTS for the storage installation 1 of FIG. 9A given the order information 9B. The SCTS determines that the ambient storage compartment 931 should be controlled to be frozen, to receive the order 950. No other temperature changes are required, for example the chilled compartment 921 may be controlled to remain chilled. In this way, the order 940 may be allocated to chilled compartment 921, the order 950 may be allocated fully to large frozen compartment 931, and the order 960 may be allocated to the frozen storage compartment 913, chilled compartment 923 and ambient compartment 933. Four vacant lockable storage compartments 911, 912, 922, 932 remain available.

The predetermined storage capacity is selected to be less than a physical storage capacity of the lockable storage compartments 12, i.e. less than a physical number of the lockable storage compartments 12. In this way at least one lockable storage space will be scheduled to remain vacant, ensuring a buffer in the case of malfunction of a storage compartment 12 requiring items to be moved, or an unexpectedly large order due to unplanned item amendments. For example, if the storage installation 1 comprises 15 lockable storage compartments 12, the predetermined storage capacity may be defined as less than 15 of the lockable storage compartments 12, such as 13 lockable storage compartments 12. In this way at least 2 lockable storage compartments will be available as a buffer. According to some embodiments the predetermined storage capacity is selected to be between 60 and 95%, or 70% and 90% of the total number of lockable storage compartments, to ensure an adequate buffer is present. For example, the predetermined storage capacity may be 80% of the total number of lockable storage compartments.

If the predetermined storage capacity cannot be met, for example due to an influx of too many orders, the central control system 101 may flag this error to a user 50 of the system, for example the customer placing the order. According to some embodiments, the error may be flagged during placement of the order by the user 50. The central control system 101 may provide an indication to the user 50 that there is insufficient capacity to accommodate the order. The indication may comprise alternative time slots that would be available to accommodate the order. Additionally or alternatively, the central control system 101 may output an indication that one or more orders should be delivered to a different installation, for example to one or more back up storage locations.

The SCTS may be determined in dependence on one or more further considerations additionally to the order information.

Environmental and physical constraints may cause certain temperature changes to be unfeasible. Step 830 may then comprise determining a time required to change a temperature of at least some of the plurality of storage compartments 12 and determining the SCTS in dependence thereon. For example, maximally utilizing the predetermined storage capacity may require changing the temperature of one or more storage compartments 12 significantly, e.g. from ambient to frozen, as in FIG. 9C. Step 830 may comprise determining how long such a change would take given the physical constraints of the storage compartment 12. If the change is determined to take longer than is available given the delivery time indicated by the ODI, the SCTS may be determined to avoid the change being required by allocating the orders in an alternative way.

The step 830 may comprise determining a surrounding temperature indicative of the temperature proximal to the storage installation 1. Determining the surrounding temperature may comprise measuring the surrounding temperature, for example by communicating with a temperature measurement device. The surrounding temperature may be stored, for example in relation to weather information, in a location accessible by the central control system 101. Determining the surrounding temperature may comprise retrieving the weather information. Determining the time required to change the temperature may then be determined in dependence on the surrounding temperature. For example, in a warm environment with a comparatively high surrounding temperature, the time taken to chill a compartment to a frozen temperature may increase.

Step 830 may comprise determining the SCTS in dependence on information indicative of a thermal cooling capacity of one or more cooling units for cooling some of the storage compartments 12. The thermal cooling capacity of the cooling units may determine whether a storage compartment 12 is capable of being cooled sufficiently to achieve a chilled or a frozen temperature. For example, larger storage compartments 12 may be unable to be cooled to a frozen temperature due to inadequate cooling capacity. Optionally, the SCTS may be determined in dependence on a combination of the thermal cooling capacity and the surrounding temperature. The surrounding temperature may further impact the thermal cooling capacity of the cooling units for differently sized storage compartments 12. For example, in the case of a high surrounding temperature, the SCTS illustrated by FIG. 9C may not be feasible due to the cooling capacity being inadequate to cool the large compartment 931 to frozen. In this case, the SCTS may be amended to instead allocate the order 950 to two small compartments 912, 922. In this case the SCTS would comprise cooling the small storage compartment 922 from chilled to frozen, which may be deemed achievable given the time for cooling, thermal cooling capacity of the cooling unit of compartment 922, and the surrounding temperature.

The method 800 comprises a step 840 of controlling the temperature of at least some of the plurality of storage compartments according to the SCTS determined in step 830. The central control system 101 may be configured to adjust the temperature of each storage compartment 12 to the target temperature (e.g. frozen) indicated by the SCTS, by the time indicated by the SCTS.

In this way the storage installation 1 will be prepared for the upcoming demand as determined through received and predicted orders. Furthermore, the compartments will be maximally utilized with an additional buffer such that the storage compartments 12 are best placed to be prepared to receive further orders.

Advantageously, the implementation of this schedule improves the availability of suitable storage space for future demand. The provision of a buffer of storage compartments as described will reduce user inconvenience, for example due to having to relocate items to an external storage facility if the compartment 12 becomes unexpectedly unusable.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A computer-implemented method of controlling a storage apparatus having a plurality of lockable storage compartments wherein at least some of the storage compartments are temperature controlled, the method comprising:
obtaining storage compartment temperature information, SCTI, for at least some of the plurality of storage compartments, the SCTI being indicative of a temperature for each storage compartment;
obtaining order information associated with a likelihood of at least one order of items being placed for storage in the storage apparatus, wherein the order information comprises order delivery information, ODI, indicative of a predicted delivery time for the order to the storage apparatus and order temperature information, OTI, indicative of a required storage temperature for at least some of the items associated with the order;
determining a storage compartment temperature schedule, SCTS, in dependence on the order information, wherein the SCTS is indicative of a temperature control schedule for the at least some of the plurality of storage compartments, and wherein the SCTS is determined to maximally utilize a predetermined storage capacity of the storage apparatus, the predetermined storage capacity being selected as less than a physical number of the lockable storage compartments; and
controlling the temperature of at least some of the plurality of storage compartments according to the SCTS.

2. The method of claim 1, wherein obtaining the order information comprises receiving, from a remote computer system, a storage request indicative of the placement of at least one of the order(s) of items for storage in the storage apparatus.

3. The method of claim 1, wherein obtaining the order information comprises:
obtaining historic order information associated with a plurality of historic orders of items for storage in the storage apparatus, and
determining the likelihood of at least one of the order(s) of items being placed in dependence on the historic order information.

4. The method of claim 3, wherein the historic order information comprises historic weather information indicative of weather conditions associated with the plurality of historic orders; and wherein obtaining the order information comprises:
obtaining predicted weather information; and
determining the likelihood of at least one of the order(s) of items being placed further in dependence on the historic weather information and the predicted weather information.

5. The method of claim 1, wherein the order information is associated with a plurality of items and the OTI is indicative of a first one or more items being requiring a first storage temperature and a second one or more items requiring a second storage temperature.

6. The method of claim 1, wherein the determining the SCTS is performed in dependence on information indicative of a time required to change a temperature of the at least some of the plurality of storage compartments.

7. The method of claim 6, comprising determining an ambient temperature proximal to the storage apparatus, wherein the time required to change the temperature of the at least some of the plurality of storage compartments is determined in dependence on the ambient temperature.

8. The method of claim 1, wherein the determining the SCTS is performed in dependence on information indicative of a thermal cooling capacity of one or more cooling units for cooling the at least some of the plurality of storage compartments.

9. The method of claim 8, wherein the determining the SCTS is performed in dependence on information indicative of a thermal cooling capacity and an ambient temperature proximal to the storage apparatus.

10. The method of claim 1, wherein the predetermined storage capacity is selected as between 70 and 90% of the total number of lockable storage compartments.

11. A controller for a storage apparatus having a plurality of lockable storage compartments wherein at least some of the storage compartments are temperature controlled, the controller being arranged to:
obtain storage compartment temperature information, SCTI, for at least some of the plurality of storage compartments, the SCTI being indicative of a temperature for each storage compartment;
obtain order information associated with a likelihood of at least one order of items being placed for storage in the storage apparatus, wherein the order information comprises order delivery information, ODI, indicative of a predicted delivery time for the order to the storage apparatus and order temperature information, OTI, indicative of a required storage temperature for at least some of the items associated with the order;
determine a storage compartment temperature schedule, SCTS, in dependence on the order information, wherein the SCTS is indicative of a temperature control schedule for the at least some of the plurality of storage compartments, and wherein the SCTS is determined to maximally utilize a predetermined storage capacity of the storage apparatus, the predetermined storage capacity being selected as less than a physical number of the lockable storage compartments; and
control the temperature of at least some of the plurality of storage compartments according to the SCTS.

12. The controller of claim 11, wherein the controller is arranged to obtain the order information by receiving, from a remote computer system, a storage request indicative of the placement of at least one of the order(s) of items for storage in the storage apparatus.

13. The controller of claim 11, wherein the controller is arranged to obtain the order information by:
obtaining historic order information associated with a plurality of historic orders of items for storage in the storage apparatus, and
determining the likelihood of at least one of the order(s) of items being placed in dependence on the historic order information.

14. The controller of claim 13, wherein the historic order information comprises historic weather information indicative of weather conditions associated with the plurality of historic orders; and wherein the controller is arranged to obtain the order information by:
obtaining predicted weather information; and
determining the likelihood of at least one of the order(s) of items being placed further in dependence on the historic weather information and the predicted weather information.

15. The controller of claim 11, wherein the order information is associated with a plurality of items and the OTI is indicative of a first one or more items being requiring a first storage temperature and a second one or more items requiring a second storage temperature.

16. The controller of claim 11, wherein the controller is arranged to determine the SCTS in dependence on information indicative of a time required to change a temperature of the at least some of the plurality of storage compartments.

17. The controller of claim 16, wherein the controller is arranged to determine an ambient temperature proximal to the storage apparatus, wherein the time required to change the temperature of the at least some of the plurality of storage compartments is determined in dependence on the ambient temperature.

18. The controller of claim 11, wherein the controller is arranged to determine the SCTS in dependence on information indicative of a thermal cooling capacity of one or more cooling units for cooling the at least some of the plurality of storage compartments.

19. The controller of claim 18, wherein the controller is arranged to determine the SCTS in dependence on information indicative of a thermal cooling capacity and an ambient temperature proximal to the storage apparatus.

20. The controller of claim 11, wherein the predetermined storage capacity is selected as between 70 and 90% of the total number of lockable storage compartments.

21. A storage apparatus having a plurality of lockable storage compartments wherein at least some of the storage compartments are temperature controlled, the storage apparatus comprising a controller according to claim 11.

22. A computer-readable data storage medium storing computer-readable instructions which, when executed by one or more processors, perform a method comprising steps of:
obtaining storage compartment temperature information, SCTI, for at least some of the plurality of storage compartments, the SCTI being indicative of a temperature for each storage compartment;
obtaining order information associated with a likelihood of at least one order of items being placed for storage in the storage apparatus, wherein the order information comprises order delivery information, ODI, indicative of a predicted delivery time for the order to the storage apparatus and order temperature information, OTI, indicative of a required storage temperature for at least some of the items associated with the order;
determining a storage compartment temperature schedule, SCTS, in dependence on the order information, wherein the SCTS is indicative of a temperature control schedule for the at least some of the plurality of storage compartments, and wherein the SCTS is determined to maximally utilize a predetermined storage capacity of the storage apparatus, the predetermined storage capacity being selected as less than a physical number of the lockable storage compartments; and
controlling the temperature of at least some of the plurality of storage compartments according to the SCTS.
